(19) United States
(12) Patent Application Publication
(10) Pub. No.: US 2022/0274351 A1
(43) Pub. Date: Sep. 1, 2022

(54) A TENSIONING MEMBER FOR AN INFLATABLE PRODUCT AND A METHOD FOR MANUFACTURING A TENSIONING MEMBER AND INFLATABLE PRODUCT

(71) Applicant: BESTWAY INFLATABLES & MATERIAL CORP., Shanghai (CN)

(72) Inventor: Shuiyong HUANG, Shanghai (CN)

(21) Appl. No.: 17/626,416

(22) PCT Filed: Jul. 9, 2020
(86) PCT No.: PCT/CN2020/100973

§ 371 Date: Jan. 11, 2022

(30) Foreign Application Priority Data
Jul. 12, 2019 (CN) 201910627640.8
Jul. 12, 2019 (CN) 201921087362.3

(51) Int. Cl. B29C 65/00; A47C 27/08

(52) U.S. Cl. CPC B29C 66/438; A47C 27/087; B29L 2022/02

(57) ABSTRACT

A tensioning member (111) for an inflatable product is delineated. The tensioning member (111) comprises a base (11) and a plurality of protrusions (12). The plurality of protrusion (12) are coupled to the base (11). Each protrusion of the plurality of protrusions (12) extends from the base (11) in a same direction and are spaced apart from one another. A method for manufacturing the tensioning member (111) and a method for manufacturing an inflatable product including the tensioning member (111) are also disclosed herein.

### CROSS-REFERENCE TO RELATED APPLICATION

The present application claims priority to Chinese Patent Application Ser. No. CN201921087362.3, filed on Jul. 12, 2019, and Chinese Patent Application Ser. No. CN201910627640.8, filed on Jul. 12, 2019, the entire disclosures of which are hereby incorporated herein by reference in their entireties.

### TECHNICAL FIELD

The present invention relates generally to a tensioning member for an inflatable product and a method of manufacturing a tensioning member and an inflatable product.

### BACKGROUND

Inflatable products, such as inflatable pools, inflatable rafts, and inflatable mattresses, are widely used outdoors, in water sports or as household products due to their lightweight and easy storage.

In the inflatable products, a tensioning member is typically used to couple chamber walls of the inflatable product to form and maintain a predetermined shape after inflation. As best shown in FIG. 1, a tensioning member 111 in an existing inflatable product is generally in the form of a complete sheet. One side of the tensioning member 111 is coupled to an upper inflatable chamber wall of an inflatable mattress, while the other side of the tensioning member 111 is coupled to a lower inflatable chamber wall of the inflatable mattress. After the inflatable mattress has been inflated, the holding force of the tensioning member on the upper and lower inflatable chamber walls of the inflatable mattress causes the entire inflatable chamber to maintain the desired mattress shape. The consumption of material for making the current tensioning members is usually very large when manufacturing the inflatable mattress. To reduce the material of the tensioning member and form a predetermined pattern, as best illustrated in FIG. 2, a plurality of holes can be punched in the middle portion of the tensioning member 112, leaving the tensioning member with apertures. However, the materials removed during punching are difficult to recycle, resulting in waste of resources and increased manufacturing costs.

### SUMMARY OF THE INVENTION

The present invention resolves the existing problems above as well as other problems by, among other things, providing a tensioning member wherein, when manufacturing the tensioning member, at least two tensioning members can be formed from a single sheet of material used to make a traditional sized (or any other desired size) tensioning members. In other words, the present invention can form at least two separate tensioning members from a single sheet of material which can be used as two separate tensioning members. This results in a reduction of the material and manufacturing costs for making the tensioning members. The tensioning members of the present invention also have the advantages of being lightweight. Moreover, the tensioning members can be coupled to each other or assembled together via a connector to form various shapes.

It is an aspect of the present invention to provide a tensioning member for an inflatable product. The tensioning member comprises a base and a plurality of protrusions. The plurality of protrusion are coupled to the base. Each protrusion of the plurality of protrusions extends from the base in a same direction and are spaced apart from one another.

It is another aspect of the present invention to provide a method for manufacturing a tensioning member for an inflatable product. The method comprises providing a sheet and cutting the sheet to form at least two tensioning members. Each tensioning member of the at least two tensioning members comprises a base and a plurality of protrusions. The base and the plurality of protrusions are formed from a single sheet of material. Each protrusion of the plurality of protrusions extends from the base in a same direction and are spaced apart from one another.

It is another aspect of the present invention to provide a method for manufacturing an inflatable product. The inflatable product has a first wall, a second wall, and a sidewall. The method comprises providing a sheet and cutting the sheet to form at least two tensioning members. Each tensioning member of the at least two tensioning members comprises a base and a plurality of protrusions. The base and the plurality of protrusions are formed from a single sheet of material. Each protrusion of the plurality of protrusions extends from the base in a same direction and are spaced apart from one another. The method further includes joining the at least two tensioning members to the inflatable product.

### BRIEF DESCRIPTION OF THE DRAWINGS

Other features and advantages of the present invention will be better understood from exemplary embodiments hereinafter described in detail with reference to the accompanying drawings. In the accompanying drawings, the same or similar reference numerals represent the same or similar components, in which:

FIG. 1 is a perspective view of an inflatable mattress including a tensioning member constructed in accordance with the prior art;

FIG. 2 is a perspective view of an inflatable mattress including a tensioning member constructed in accordance with the prior art;

FIG. 3 is a side view of a tensioning member for an inflatable product constructed according to an embodiment of the present invention;

FIGS. 4a and FIG. 4b are perspective views of an inflatable mattress including a tensioning member constructed according to an embodiment of the present invention;

FIGS. 5a and FIG. 5b are perspective views of an inflatable pool including a tensioning member constructed according to an embodiment of the present invention;

FIG. 6a is a perspective view of an inflatable mattress including a tensioning member constructed according to an embodiment of the present invention;

FIG. 6b is an enlarged partial view of the inflatable mattress of FIG. 6a;

FIG. 6c is a perspective view of an inflatable mattress including a tensioning member constructed according to an embodiment of the present invention;

FIG. 7a is a perspective view of an inflatable mattress including a tensioning member constructed according to an embodiment of the present invention;

FIG. 7b is an enlarged partial view of the inflatable mattress of FIG. 7a;

FIG. 8 is an enlarged partial view of the inflatable mattress including a tensioning member constructed according to an embodiment of the present invention;

FIGS. 9a-9d are side views of tensioning members manufactured according to a method of the present invention;

FIGS. 10a to 10d are flowcharts of methods for manufacturing an inflatable product according to embodiments of the present invention;

FIGS. 11a to 11d are side views of tensioning members manufactured according to a method of the present invention; and

FIG. 12 is a cross-sectional view of tensioning members in an inflatable product according to embodiments of the present invention.

### DETAILED DESCRIPTION OF THE INVENTION

The implementation and application of the embodiments of the present invention will be discussed in detail below. However, it should be understood that the specific embodiments discussed only illustratively the various implementation and use of the present invention, and are not intended to limit the scope of the present invention. In the description, the structural positions of various components, e.g., upper, lower, top, bottom, etc., are not absolute, but relative. The orientation expressions are appropriate when the various components are arranged, as shown in the Figures, but should change accordingly when the positions of the various components in the Figures change.

As used herein, the “first”, “second”, and “third” cannot be used to limit the order and the number of components unless otherwise specifically stated.

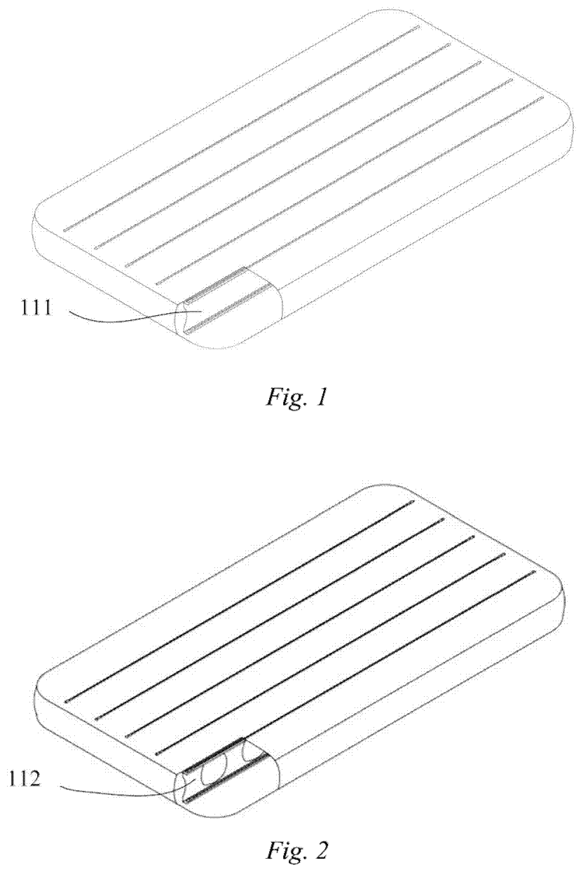

An inflatable product containing at least one tensioning member 111, 112 constructed in accordance with the prior art is generally shown in FIGS. 1 and 2. As best illustrated in FIG. 1, the tensioning member 111 in the existing inflatable product is generally in the form of a complete sheet. One side of the tensioning member 111 couples to an upper inflatable chamber wall of an inflatable mattress, while the other side of the tensioning member 111 couples to a lower inflatable chamber wall of the inflatable mattress. After the inflatable mattress has been inflated, a holding force of the tensioning member 111 on the upper and lower inflatable chamber walls of the inflatable mattress causes the entire inflatable chamber to form a predetermined rectangular shape, i.e., a mattress shape. It should be noted that material consumption and costs for making the tensioning member 111 in existing inflatable products are typically very large. To reduce these costs, the tensioning member 111 is designed to have a predetermined pattern. For example, as best illustrated in FIG. 2, a plurality of holes can be punched in the middle portion of the tensioning member 112. However, the materials removed during punching are difficult to recycle, resulting in waste of resources and increased manufacturing costs.

The present invention resolves the and other above problems by, among other things, providing a tensioning member wherein, when manufacturing the tensioning member, at least two tensioning members can be formed from a single sheet of material used to make a traditional sized (or any other desired size) tensioning member. In other words, the present invention can form at least two separate tensioning members from a single sheet of material which can be used as two separate tensioning members. This results in a reduction of the material and manufacturing costs for making the tensioning members. The tensioning members of the present invention also have the advantages of being lightweight. Moreover, the tensioning members can be coupled to each other or assembled together via a connector to form various shapes.

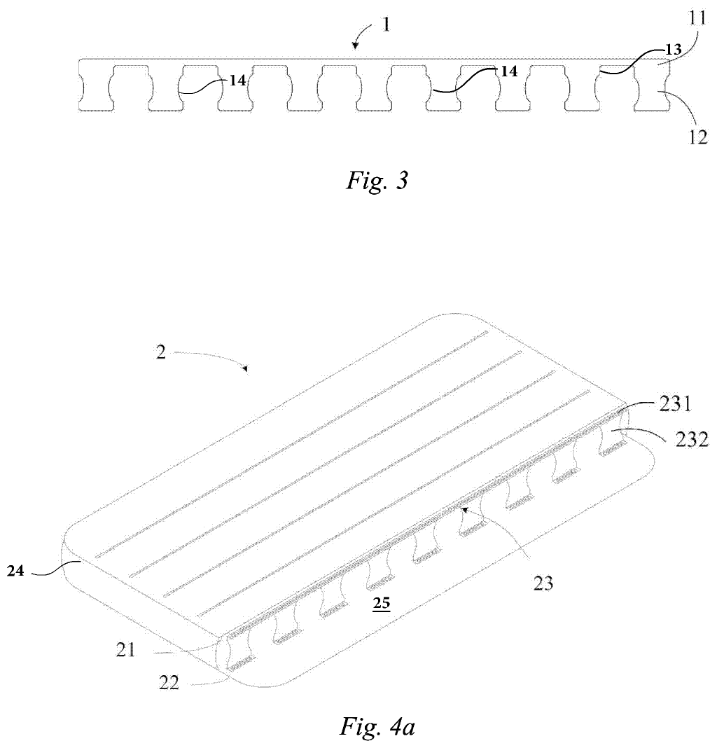

FIG. 3 shows a tensioning member 1 constructed in accordance with an embodiment of the present invention. The tensioning member 1 comprises a base 11 and a plurality of protrusions 12. The plurality of protrusions 12 are coupled to the base 11 wherein each protrusion of the plurality of protrusions 12 extends from the base 11 in a same direction and are spaced apart from one another. According to an embodiment of the present invention, the base 11 and the plurality of protrusions 12 are formed from a single sheet of material. In other words, the base 11 and a plurality of protrusions 12 can be monolithically and integrally formed.

Also shown in FIG. 3, the plurality of protrusions 12 can be evenly spaced apart from one another and define grooves 13 located between adjacent protrusions 12. Each protrusion of the plurality of protrusions 12 can have the same shape. Optionally, in some embodiments of the present invention, the shapes for each protrusion of the plurality of protrusions 12 can be different, and the protrusions 12 can also be unevenly spaced.

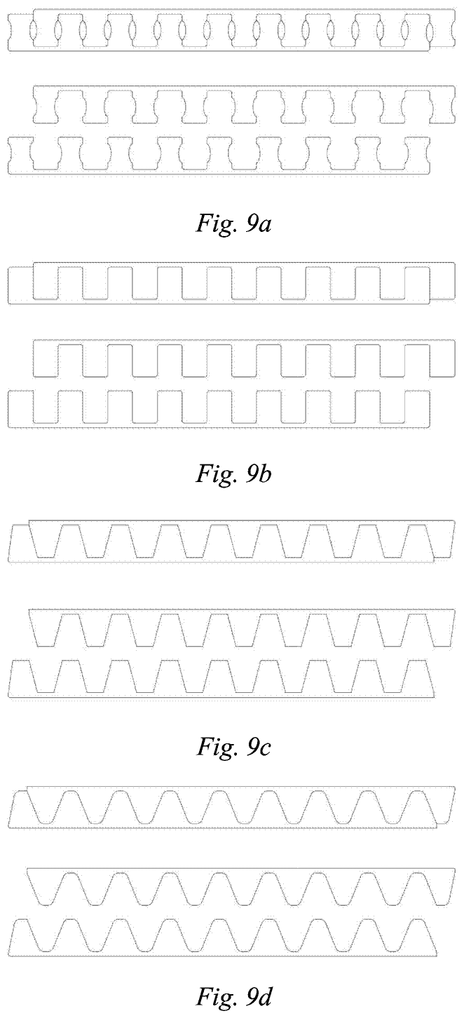

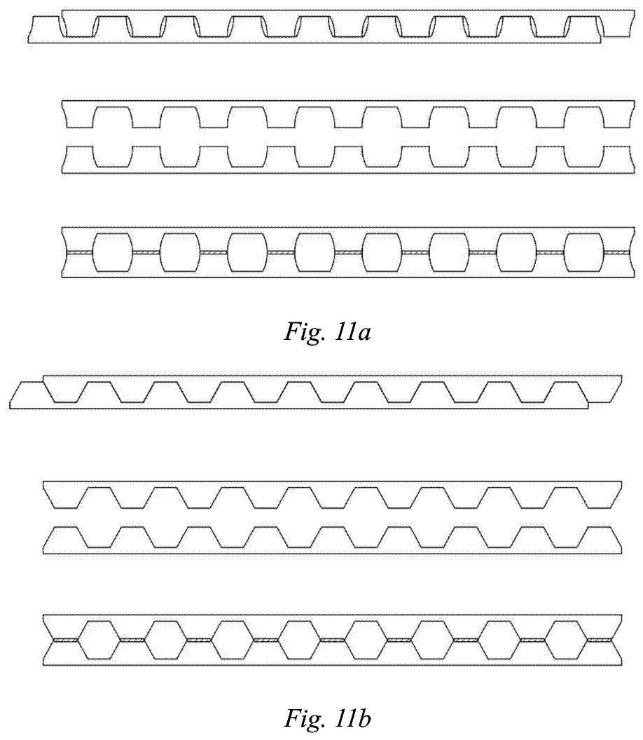

According to an embodiment of the present invention, each protrusion 12 of the plurality of protrusions 12 can have a generally hourglass shape. The protrusions 12 extends between two ends with one end being adjacent to the base 11 while the other end is distal from the base 11. Optionally, the protrusions 12 can have a tapered width, gradually expanding width, tapered and then gradually expanding width, gradually expanding and then tapered width, or a constant width from the one end adjacent to the base 11 toward the other end apart from the base 11. In other words, the protrusions 12 can have various different and any desired shapes, such as but not limited to a rectangular shape (shown in FIGS. 9b and 11d), a square shape, a trapezoid shape (shown in FIGS. 9c and 11b), a wavy shape (shown in FIG. 9d), a trapezoid shape with inwardly-recessed lateral sides (shown in FIG. 11a), a trapezoid shape with outwardly-raised lateral sides (shown in FIG. 11c), or an hourglass shape (shown in FIG. 9a). According to an embodiment of the present invention, and as shown in FIG. 3, each protrusion of the plurality of protrusions 12 can include a pair of arcuate shaped lateral sides 14 to establish the hourglass shape.

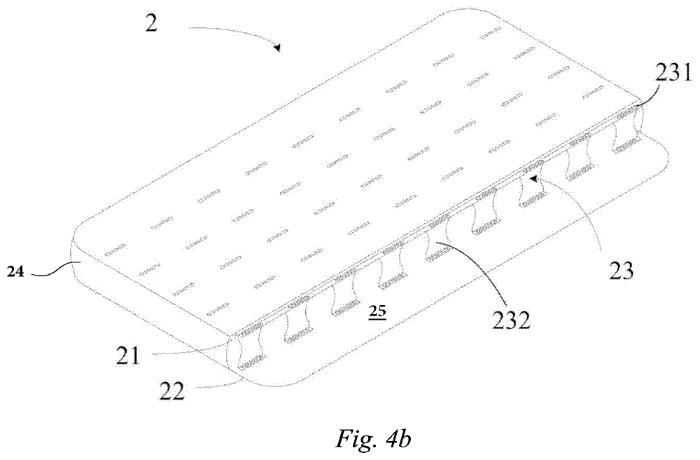

FIGS. 4a and 4b shows an inflatable product 2 including a tensioning member 23 constructed according to an embodiment of the present invention. As shown in FIGS. 4a and 4b, a first inflatable mattress 2 comprises a first wall 21, a second wall 22, and a sidewall 24. The first wall 21 and the second wall 22 are arranged opposite one another. The sidewall 24 couples to the first wall 21 and the second wall 22 and extends about a periphery of the first wall 21 and a periphery of the second wall 22. An inflatable chamber 25 is defined by the first wall 21, the second wall 22, and the sidewall 24. The first inflatable mattress 2 also comprises a plurality of tensioning members 23 located in the inflatable chamber 25. The tensioning members 23 comprises a base 231 and a plurality of protrusions 232. The base 231 and the plurality of protrusions 232 are integrally provided, i.e. formed from a single sheet of material. It should be understood by one of ordinary skill in the art that the plurality of protrusions provided integrally can be also formed integrally from multiple sheets of material. At least some protrusions of the plurality of protrusions 232 extend from the base 231 in a same direction and are spaced apart from one another. The base 231 of the tensioning members 23 couples to the first wall 21, and an end of each protrusion of the plurality of protrusions 232 of the tensioning members 23 couples to the second wall 22. As illustrated in FIG. 4a, the base 231 of the tensioning member 23 is entirely coupled to the first wall 21. According to another embodiment of the present invention and as illustrated in FIG. 4b, the base 231 of the tensioning member 23 may be only partially coupled to the first wall 21. The difference in connection modes in FIGS. 4a and 4b allows for different appearance of the inflatable mattress, particularly when inflated.

FIGS. 5a and 5b illustrate an inflatable product constructed according to an embodiment of the present invention. As shown in FIGS. 5a and 5b, the inflatable product is an inflatable pool/spa 3. The inflatable pool/spa 3 comprises a first wall 31, a second wall 32, and a sidewall 34. The first wall 31 and the second wall 32 are arranged in a concentric relationship and located opposite of one another. A sidewall 34 extends between the first wall 31 and the second wall 32 to couple the first wall 31 to the second wall 32. The first wall 31, the second wall 32, and the sidewall 34 define an inflatable chamber 35 extending therebetween. The inflatable pool/spa 3 also comprises a plurality of tensioning members 33 located in the inflatable chamber 35. The tensioning members 33 comprises a base 331 and a plurality of protrusions 332. The base 331 and the plurality of protrusions 332 are integrally provided, i.e. formed from a single sheet of material. It should be understood by one of ordinary skill in the art that the plurality of protrusions provided integrally can be also formed integrally from multiple sheets of material. At least some protrusions of the plurality of protrusions 332 extend from the base 331 in a same direction and are spaced apart from one another. The base 331 of the tensioning member 33 couples to the first wall 31, and an end of each protrusion of the plurality of protrusions 332 of the tensioning members 33 couples to the second wall 32. As illustrated in FIG. 5a, the base 331 of the tensioning member 33 is entirely coupled to the first wall 31. According an embodiment of the present invention and as best illustrated in FIG. 5b, the base 331 of the tensioning members 33 may be only partially coupled to the first wall 31. The difference in the connection modes in FIGS. 5a and 5b allows for different appearance of the inflatable pool/spa 3, particularly when inflated.

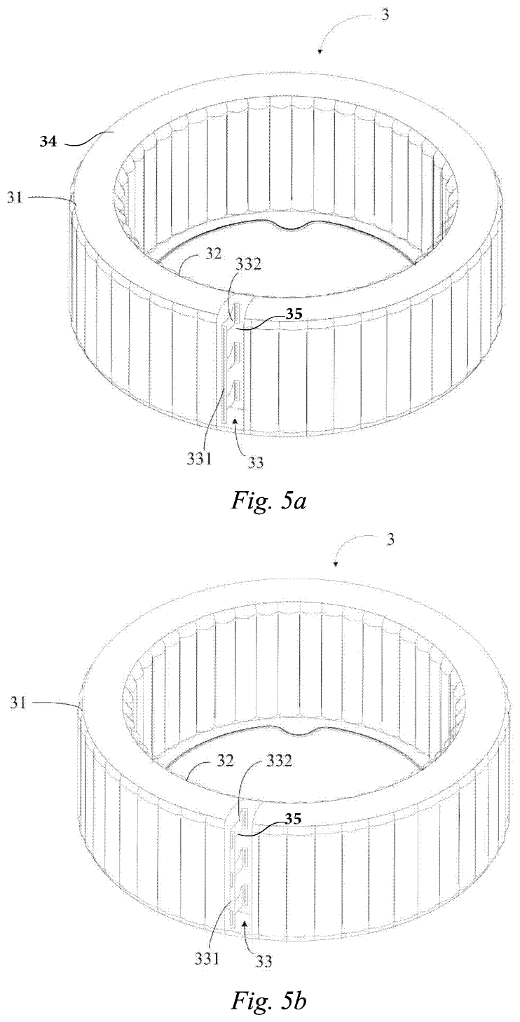

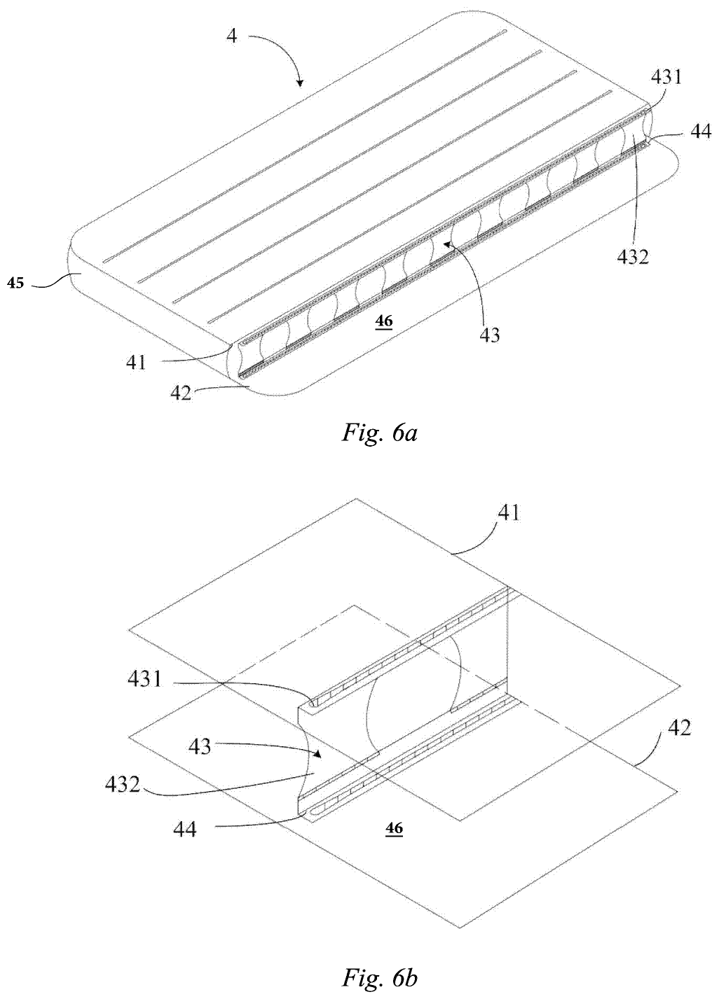

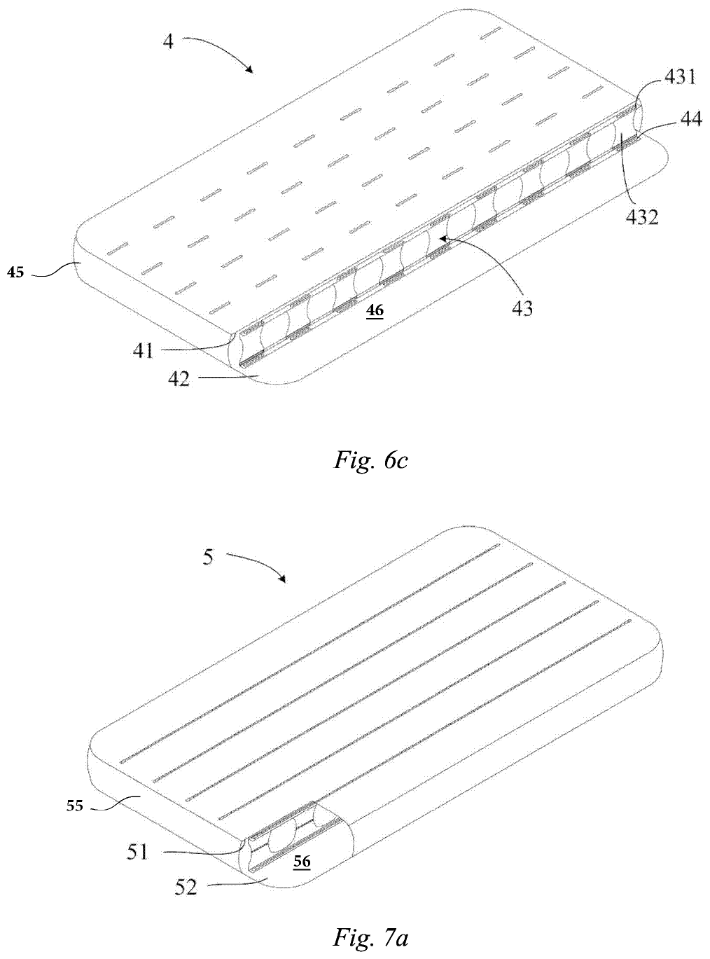

FIGS. 6a and 6c illustrate an inflatable product constructed according to an embodiment of the present invention. FIG. 6b is a partial enlarged view of the inflatable product shown in FIG. 6a. As shown in FIGS. 6a and 6b, a second inflatable mattress 4 comprises a first wall 41, a second wall 42, and a sidewall 45. The first wall 41 and the second wall 42 are arranged opposite one another. The sidewall 45 couples to the first wall 41 and the second wall 42 and extends about a periphery of the first wall 41 and a periphery of the second wall 42. An inflatable chamber 46 is defined by the first wall 41, the second wall 42, and the sidewall 45. The second inflatable mattress 4 also comprises a plurality of tensioning members 43 located in the inflatable chamber 46. The tensioning members 43 comprises a base 431 and a plurality of protrusions 432. The base 431 and the plurality of protrusions 432 are integrally provided, i.e. formed from a single sheet of material. It should be understood by one of ordinary skill in the art that the plurality of protrusions provided integrally can be also formed integrally from multiple sheets of material. At least some protrusions of the plurality of protrusions 432 extend from the base 431 in a same direction and are spaced apart from one another. The base 431 of the tensioning members 43 couples to the first wall 41, and an end of each protrusion of the plurality of protrusions 432 of the tensioning members 43 couples to the second wall 42 via a connector 44. The connector 44 may be made of the same material as the tensioning members 43. The connector 44 may be made of any material capable of being coupled to both the tensioning member 43 and the first wall 41 and the second wall 42, such as but not limited to PVC, TPR, EVA or other composite materials. As shown in FIGS. 6a and 6b, the base 431 of the tensioning member 43 is entirely coupled to the first wall 41. According to another embodiment of the present invention and as illustrated in FIG. 6c, the base 431 of the tensioning member 43 may be partially coupled to the first wall 41. Optionally, the connector 44 can be wholly or partially coupled to the second wall 42. In this arrangement, the connector 44 provides a reinforcing effect and can facilitate the mounting of the tensioning member 43 to the second inflatable mattress 4.

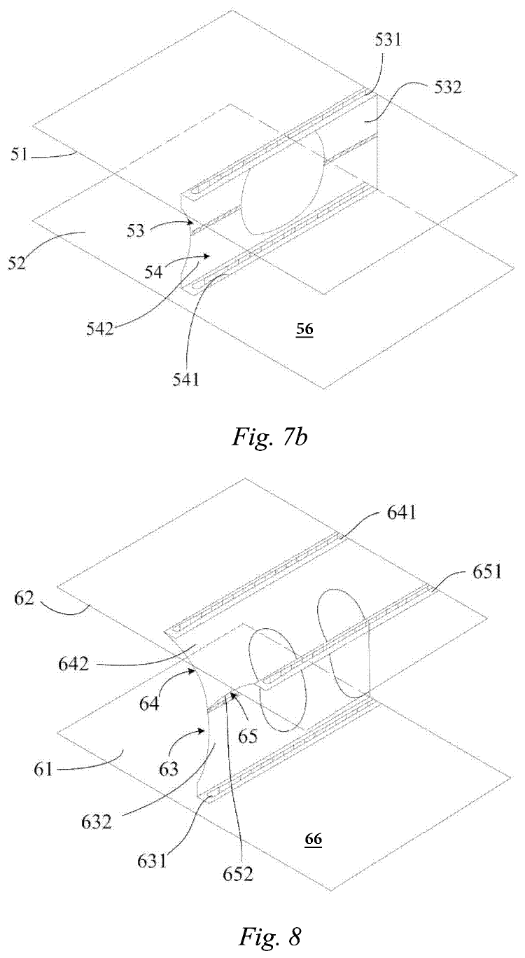

FIG. 7a illustrates an inflatable product constructed according to an embodiment of the present invention. FIG. 7b is a partial enlarged view of FIG. 7a. As illustrated in FIGS. 7a and 7b, a third inflatable mattress 5 comprises a first wall 51, a second wall 52, and a sidewall 55. The first wall 51, the second wall 52 are arranged opposite one another. The sidewall 55 couples to the first wall 51 and the second wall 52 and extends about a periphery of the first wall 51 and a periphery of the second wall 52. An inflatable chamber 56 is defined by the first wall 51, the second wall 52, and the sidewall 55. The third inflatable mattress 5 also comprises a plurality of tensioning members 53, 54 located in the inflatable chamber 56. The plurality of tensioning members 53, 54 includes a first tensioning member 53 and a second tensioning member 54. The first tensioning member 53 comprises a base 531 and a plurality of protrusions 532. The base 531 and the plurality of protrusions 532 are integrally provided, i.e. formed from a single sheet of material. It should be understood by one of ordinary skill in the art that the plurality of protrusions provided integrally can be also formed integrally from multiple sheets of material. At least some protrusions of the plurality of protrusions 532 extend from the base 531 in a same direction and are spaced apart from one another. The second tensioning member 54 comprises a base 541 and a plurality of protrusions 542. The base 541 and the plurality of protrusions 542 are integrally provided, i.e. formed from a single sheet of material. It should be understood by one of ordinary skill in the art that the plurality of protrusions provided integrally can be also formed integrally from multiple sheets of material. At least some protrusions of the plurality of protrusions 542 extend from the base 541 in a same direction and are spaced apart from one another.

According to an embodiment of the present invention, the base 531 of the first tensioning member 53 couples to the first wall 51. The base 541 of the second tensioning member 54 couples to the second wall 52. Ends of each protrusion of the plurality of protrusions 532 of the first tensioning members 53 couple to ends of each protrusion of the plurality of protrusions 542 of the second tensioning member 54 to form an integrated tensioning member to provide structural support to the third inflatable mattress 5. As shown in FIGS. 7a and 7b, the base 531 of the first tensioning member 53 is entirely coupled to the first wall 51 and the base 541 of the second tensioning member 54 is entirely coupled to the second wall 52. Although not shown, according to another embodiment of the present invention, the base 531 of the first tensioning member 53 may be partially coupled to the first wall 51, and the base 541 of the second tensioning member 54 may be partially coupled to the second wall 52. In this arrangement, the plurality of protrusions 532 of the first tensioning member 53 are sequentially coupled to the plurality of protrusions 542 of the second tensioning member 54 to form an integrated tensioning member with complete upper and lower edges such that the material for manufacturing the first and second tensioning members 53, 54 can be effectively utilized, and at the same time, the inflatable product using the integrated tensioning member is provided with a flat exterior surface. In this embodiment, since the height of the first and second tensioning members 53, 54 is approximately half of the entire height of the integrated tensioning member, the height of the protrusions 532, 542 of the first and second tensioning members 53, 54 can be reduced. In this way, during the manufacturing process, accidental folding or deformation of the protrusions 532, 542 of the first and second tensioning members 53, 54 can be avoided, thereby reducing product defects.

FIG. 8 is an enlarged partial view of an inflatable product including a tensioning member constructed in accordance with an embodiment of the present invention. The inflatable product is similar to the inflatable product illustrated in FIGS. 4a-5b which includes but is not limited to an inflatable mattress and/or an inflatable pool/spa. As shown in FIG. 8, the inflatable product comprises a first wall 61, a second wall 62, and a sidewall (not shown). The first wall 61 and the second wall 62 are arranged opposite one another. The sidewall (not shown) couples to the first wall 61 and the second wall 62 and extends about a periphery of the first wall 61 and a periphery of the second wall 62. An inflatable chamber 66 is defined by the first wall 61, the second wall 62, and the sidewall (not shown). The inflatable product also comprises a plurality of tensioning members 63, 64, 65 located in the inflatable chamber 66. The plurality of tensioning members 63, 64, 65 includes a first tensioning member 63, a second tensioning member 64, and a third tensioning member 65.

The first tensioning member 63 comprises a base 631 and a plurality of protrusions 632. The base 631 and the plurality of protrusions 632 are integrally provided, i.e. formed from a single sheet of material. It should be understood by one of ordinary skill in the art that the plurality of protrusions provided integrally can be also formed integrally from multiple sheets of material. At least some protrusions of the plurality of protrusions 632 extend from the base 631 in a same direction and are spaced apart from one another. Each protrusion of the plurality of protrusions 632 of the first tensioning member 63 has a height extending between the base 631 and a distal end of the protrusion 632 spaced from the base 631.

The second tensioning member 64 comprises a base 641 and a plurality of protrusions 642. The base 641 and the plurality of protrusions 642 are integrally provided, i.e. formed from a single sheet of material. It should be understood by one of ordinary skill in the art that the plurality of protrusions provided integrally can be also formed integrally from multiple sheets of material. At least some protrusions of the plurality of protrusions 642 extend from the base 641 in a same direction and are spaced apart from one another. Each protrusion of the plurality of protrusions 642 of the second tensioning member 64 has a height extending between the base 641 and a distal end of the protrusion 642 spaced from the base 641.

The third tensioning member 65 comprises a base 651 and a plurality of protrusions 652. The base 651 and the plurality of protrusions 652 are integrally provided, i.e. formed from a single sheet of material. It should be understood by one of ordinary skill in the art that the plurality of protrusions provided integrally can be also formed integrally from multiple sheets of material. At least some protrusions of the plurality of protrusions 652 extend from the base 651 in a same direction and are spaced apart from one another. Each protrusion of the plurality of protrusions 652 of the second tensioning member 65 has a height extending between the base 651 and a distal end of the protrusion 652 spaced from the base 651.

The base 631 of the first tensioning member 63 couples to the first wall 61. The base 641 of the second tensioning member 64 couples to the second wall 62. The base 651 of the third tensioning member 65 couples to the second wall 62 and spaced apart from the base 641 of the second tensioning member 64. Each protrusion of the plurality of protrusions 632 of the first tensioning member 63 couples to each protrusion of the plurality of protrusions 642 of the second tensioning member 64. Each protrusion of the plurality of protrusions 652 of the third tensioning member 65 couples to each protrusion of the plurality of protrusions 632 of the first tensioning member 63 and each protrusion of the plurality of protrusions 642 of the second tensioning member 64.

As illustrated in FIG. 8, the base 631 of the first tensioning member 63 is entirely coupled to the first wall 61. Additionally, the base 641 of the second tensioning member 64 and the base 651 of the third tensioning member 65 are also entirely coupled to the second wall 62. Although not illustrated, the base 631 of the first tensioning member 63 can be partially coupled to the first wall 61, and the base 641 of the second tensioning member 64 and the base 651 of the third tension tensioning member 65 may be partially coupled to the second wall 62. In other words, as illustrated in FIG. 8, the first tensioning member 63, the second tensioning member 64, and the third tensioning member 65 are coupled to one another to establish a Y-shaped tensioning member.

In this arrangement, the height of the first tensioning member 63 is greater than the heights of the second tensioning member 64 and the third tensioning member 65. Optionally, according to another embodiment of the present invention, the heights of the first tensioning member 63, the second tensioning member 64 and the third tensioning member 65 can be set differently to any desired heights. For example, the tensioning member can be formed by assembling the first tensioning member 63, the second tensioning member 64 and the third tensioning member 65 at different locations (e.g., intermediate parts, corner parts, and edge parts) of different inflatable products.

It should be appreciated that the connection between the tensioning member and the first wall and/or between the tensioning members and the plurality of protrusions is high-frequency welding or adhesive bonding.

In the above exemplary embodiments, several types of tensioning members are shown using inflatable mattresses and inflatable pool/spa as examples. It will be understood that these technical solutions of the tensioning members can also be applied to other suitable inflatable products such as but not limited to inflatable water sports products. The tensioning members in the above embodiments may comprise: 1) a single tensioning member having a base and a plurality of protrusions, 2) a connector and a tensioning member having a base and a plurality of protrusions, 3) a pair of tensioning members each having a base and a plurality of protrusions, or 4) a plurality of three tensioning members each having a base and a plurality of protrusions. The protrusion of the tensioning members may be coupled, at a position other than the end, to the chamber wall or another tensioning members when necessary. In addition, the tensioning members may comprise any desired number of tensioning members each having a base and a plurality of protrusions according to different requirements. The inflatable products can also incorporate a variety of different types of tensioning members based on requirements.

It is another aspect of the present invention to provide a method for manufacturing an inflatable product and a method for manufacturing a tensioning member for an inflatable product. The method for manufacturing an inflatable product can include the method of manufacturing the tensioning member for an inflatable product. In other words, the methods for manufacturing the inflatable product can include the method for manufacturing the tensioning member for the inflatable product.

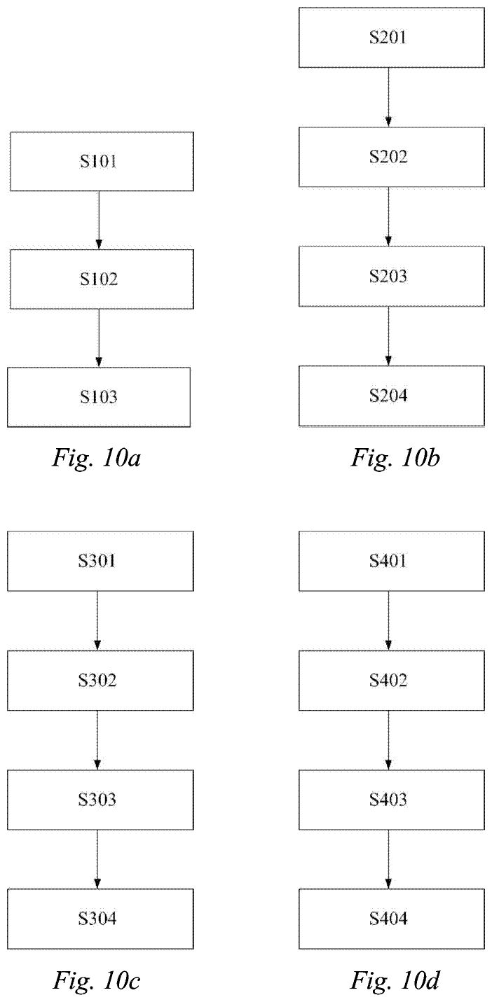

FIG. 10a illustrates a flowchart of a method for manufacturing an inflatable product according to an embodiment of the present invention. The inflatable product has a first wall, a second wall, and a side wall. The method comprises the following steps:

Step S101: providing a sheet;

Step S102: cutting the sheet to form at least two tensioning members; wherein each tensioning member of the at least two tensioning members comprises a base and a plurality of protrusions; wherein the base and the plurality of protrusions are formed from a single sheet of material; wherein each protrusion of the plurality of protrusions extends from the base in a same direction and are spaced apart from one another; and

Step S103: joining the at least two tensioning members to the inflatable product.

According to an embodiment of the present invention, the step of joining (Step S103) comprises coupling the base of each tensioning member of the at least two tensioning members to the first wall and coupling each protrusion of the plurality of protrusions of each tensioning member of the at least two tensioning members to the second wall.

According to the above steps, optionally, as shown in FIGS. 9a to 9d, the entire sheet of tensioning member material can be used to manufacture two identical tensioning members. The tensioning member 1, as shown in FIG. 3, comprises a base 11 and a plurality of protrusions 12. The plurality of protrusions 12 are coupled to the base 11 wherein each protrusion of the plurality of protrusions 12 extends from the base 11 in a same direction and are spaced apart from one another. The protrusions of the tensioning member shown in FIG. 9a have the same shape as the tensioning member 1 in FIG. 3. In addition, the shape of the protrusion of the tensioning member formed by cutting can also have a rectangular shape as exemplarily shown in FIG. 9b, a trapezoid shape as exemplarily shown in FIG. 9c, and a wavy shape as exemplarily shown in FIG. 9d. Optionally, the protrusion of the tensioning member may have the shape illustrate in FIGS. 11a to 11d or any other desired shape.

FIG. 10b illustrates a flowchart of a method for manufacturing an inflatable product according to an embodiment of the present invention. The inflatable product has a first wall, a second wall, and a side wall. The method comprises the following steps:

Step S201: providing a sheet;

Step S202: cutting the sheet to form at least two tensioning members; wherein each tensioning member of the at least two tensioning members comprises a base and a plurality of protrusions; wherein the base and the plurality of protrusions are formed from a single sheet of material; wherein each protrusion of the plurality of protrusions extends from the base in a same direction and are spaced apart from one another;

Step S203: providing a connector; and

Step S204: joining the at least two tensioning members to the inflatable product.

According to an embodiment of the present invention, the step of joining (Step S204) comprises coupling the base of each tensioning member of the at least two tensioning members to the first wall and coupling each protrusion of the plurality of protrusions of each tensioning member of the at least two tensioning members to the second wall using the connector.

It should be note that, in this exemplary embodiment, depending on the requirements of the user, the protrusions of the tensioning members can have various different shapes, such as but not limited to the shapes shown in FIGS. 9a to 9d and FIGS. 11a to 11d. Optionally, the connector can be an elongated connector for coupling each protrusion of the plurality of protrusions of each tensioning member of the at least two tensioning members to the inflatable product. In this arrangement, the tensioning members manufactured from the method may be similar to the tensioning members shown in FIGS. 6a to 6c.

FIG. 10c illustrates a flowchart of a method for manufacturing an inflatable product according to an embodiment of the present invention. The inflatable product has a first wall, a second wall, and a side wall. The method comprises the following steps:

Step S301: providing a sheet;

Step S302: cutting the sheet to form at least two tensioning members; wherein each tensioning member of the at least two tensioning members comprises a base and a plurality of protrusions; wherein the base and the plurality of protrusions are formed from a single sheet of material; wherein each protrusion of the plurality of protrusions extends from the base in a same direction and are spaced apart from one another;

Step S303: joining the at least two tensioning members by coupling an end of the each protrusion of one of the at least two tensioning members to an end of the each protrusion of the other tensioning member of the at least two tensioning members; and

Step S304: joining the at least two tensioning members to the inflatable product.

According to an embodiment of the present invention, the step of joining the at least two tensioning members to the inflatable product (Step S304) comprises coupling the base of one tensioning member of the at least two tensioning members to the first wall and coupling the base of the other tensioning member of the at least two tensioning members to the second wall.

As shown in FIGS. 11a to 11d, the entire sheet of tensioning member material can be used to manufacture two identical tensioning members. The tensioning member 1, as shown in FIG. 3, comprises a base 11 and a plurality of protrusions 12. The plurality of protrusions 12 are coupled to the base 11 wherein each protrusion of the plurality of protrusions 12 extends from the base 11 in a same direction and are spaced apart from one another. As can be seen from FIGS. 11a to 11d, the shape of the protrusions of the tensioning member can be a trapezoid with inwardly-recessed lateral sides, as shown in FIG. 11a or a trapezoid with outwardly-raised lateral sides, as shown in FIG. 11c. As illustrated in FIGS. 11a to 11d, the tensioning members are connected in a staggered manner such that an end of the protrusion of one tensioning member that is remote from the base is coupled to an end of the protrusion of the other tensioning member that is remote from the base to form an integrated tensioning member with complete upper and lower edges.

In this arrangement, the tensioning member obtained from the method may be similar to the tensioning members shown in FIGS. 7a and 7b.

FIG. 10d illustrates a flowchart of a method for manufacturing an inflatable product according to an embodiment of the present invention. The inflatable product has a first wall, a second wall, and a side wall. The method comprises the following steps:

Step S401: providing a sheet;

Step S402: cutting the sheet to form at least two tensioning members; wherein each tensioning member of the at least two tensioning members comprises a base and a plurality of protrusions; wherein the base and the plurality of protrusions are formed from a single sheet of material; wherein each protrusion of the plurality of protrusions extends from the base in a same direction and are spaced apart from one another; wherein the at least two tensioning members includes a plurality of three tensioning members,

Step S403: joining the plurality of three tensioning members by coupling an end of each protrusion of each tensioning member of the plurality of three tensioning members to one another; and

Step S404: joining the at least two tensioning members to the inflatable product.

According to an embodiment of the present invention, the step of joining the at least two tensioning members to the inflatable product (Step S404) comprises coupling the base of the first tensioning member to the first wall, coupling the base of the second tensioning member to the second wall, and coupling the base of the third tensioning member to the second wall. It should be appreciated that the plurality of three tensioning members may have different heights and every three tensioning members are coupled to one another and form a Y-shaped tensioning member. Optionally, a tensioning member in the Y-shaped tensioning member that is generally perpendicular to the first wall and the second can have a height that is greater than that of the other tensioning members. In this arrangement, the tensioning member obtained from the method may be similar to the tensioning members shown in FIG. 8.

Additionally, it should be noted that processes such as blanking, die cutting, or thermal cutting can be used to cut a sheet and form the tensioning members. More specifically, according to an embodiment of the present invention, blanking, die cutting, or thermal cutting can be carried out in a way such that a pair of tensioning members can be obtained. Optionally, the entire sheet may be blanked out or thermally cut in an assembly line, and the entire sheet may be previously formed with a sheet shape suitable for blanking or cutting to form at least one pair of tensioning members.

In all the above methods for manufacturing the inflatable product, the connection between the tensioning member and the inflatable product, and the connection between the tensioning members can be formed via high-frequency welding or adhesive bonding. The base of the tensioning member may be wholly or partially coupled to the first wall or the second wall of the inflatable product. Additionally, a connector may be used to couple the tensioning member to the first wall or the second wall of the inflatable product. Similarly, the connector may be wholly or partially coupled to the first wall or the second wall of the inflatable product.

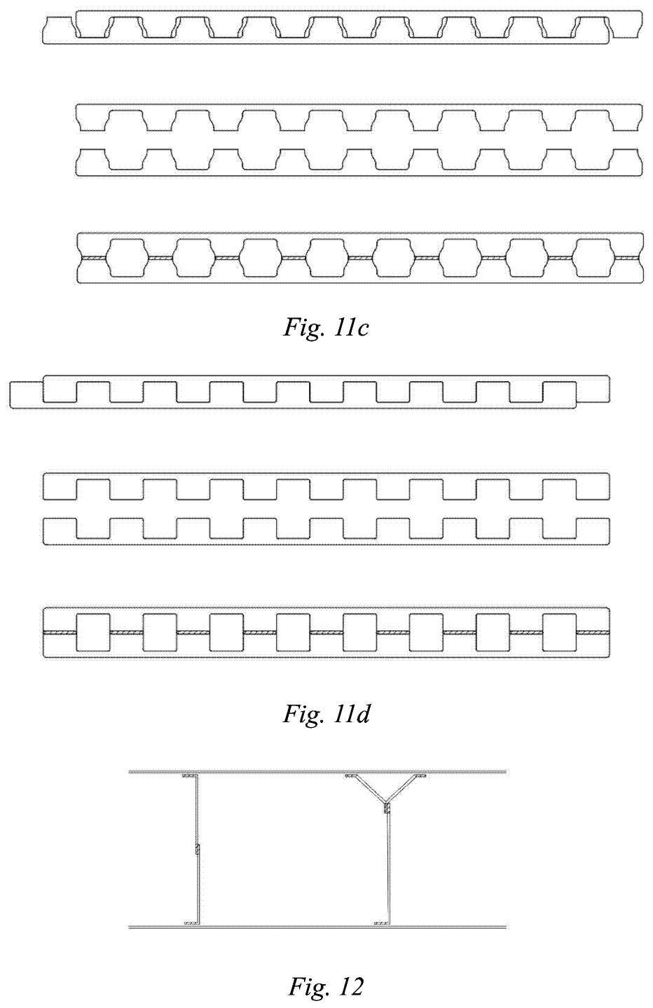

According to an embodiment of the present invention and as best illustrated in FIG. 12, the tensioning member obtained by the above manufacturing methods can form either a straight tensioning member or a Y-shaped tensioning member. It should be appreciated that the sheet can be a single-layer material such as polyvinyl chloride (“PVC”), Thermalplastic Rubber (“TPR”), Ethylene-vinyl Acetate (“EVA”) or cloth, or a multilayer material including a fabric material interposed between two adhesion layers, i.e. a fabric material being located between a pair of PVC, TPR, EVA, or cloth sheets.

In comparison with the prior art, the present invention provides a maximum utilization of material used to manufacture tensioning members. Additionally, the tensioning members formed by the present invention can be used either alone or in combination thereby reducing the total weight of the inflatable product while maximizing the utilization of resources.

The technical content and features of the present invention are disclosed herein, but it will be understood by those skilled in the art that one may make various variations and improvements to the concepts disclosed herein under the scope of the present invention, and all the variations and improvements would fall into the scope of the present invention. The descriptions of the embodiments herein are illustrative and not restrictive, and therefore, the scope of the present invention is defined by the claims.

1. A tensioning member for an inflatable product, the tensioning member comprising: a base; and a plurality of protrusions coupled to said base; wherein each protrusion of said plurality of protrusions extends from said base in a same direction and are spaced apart from one another.

2. The tensioning member according to claim 1, wherein said base and said plurality of protrusions are formed from a single sheet of material.

3. The tensioning member according to claim 1, wherein said plurality of protrusions are evenly spaced apart from one another and define grooves located between adjacent protrusions.

4. The tensioning member according to claim 1, wherein each protrusion of said plurality of protrusions has a rectangular shape, a square shape, a trapezoid shape, a wavy shape, a trapezoid shape with inwardly-recessed lateral sides, a trapezoid shape with outwardly-raised lateral sides, or an hourglass shape.

5. The tensioning member according to claim 4, wherein each protrusion of said plurality of protrusions has a pair of arcuate shaped lateral sides to establish said hourglass shape.

6. An inflatable product, comprising: a first wall; a second wall; a sidewall; an inflatable chamber defined by said first wall, said second wall and said sidewall; and said tensioning member of claim 1 located in said inflatable chamber; wherein said base of said tensioning member couples to said first wall and said plurality of protrusions couple to said second wall.

7. An inflatable product, comprising: a first wall; a second wall; a sidewall; an inflatable chamber defined by said first wall, said second wall, and said sidewall; said tensioning member of claim 1; and a connector located in said inflatable chamber; wherein said base of said tensioning member couples to said first wall and said connector couples said plurality of protrusions to said second wall.

8. An inflatable product, comprising: a first wall; a second wall; a sidewall; an inflatable chamber defined by said first wall, said second wall, and said sidewall; and a first tensioning member and a second tensioning member located in said inflatable chamber; wherein said first tensioning member and said second tensioning member comprise said tensioning member of claim 1; wherein said base of said first tensioning member couples to said first wall; wherein said base of said second tensioning member couples to said second wall; and wherein each protrusion of said plurality of protrusions of said first tensioning member couples to each protrusion of said plurality of protrusions of said second tensioning member.

9. An inflatable product, comprising: a first wall; a second wall; a sidewall; an inflatable chamber defined by said first wall, said second wall, and said sidewall; and a first tensioning member, a second tensioning member, and a third tensioning member located in said inflatable chamber; wherein said first tensioning member, said second tensioning member, and said third tensioning member comprise said tensioning member of claim 1; wherein said base of said first tensioning member couples to said first wall; wherein said base of said second tensioning member couples to said second wall, wherein each protrusion of said plurality of protrusions of said first tensioning member couples to each protrusion of said plurality of protrusions of said second tensioning member; wherein said base of said third tensioning member couples to said second wall; and wherein each protrusion of said plurality of protrusions of said third tensioning member couples to each protrusion of said plurality of protrusions of said first tensioning member and each protrusion of said plurality of protrusions of said second tensioning member.

10. The inflatable product according to claim 9, wherein a height of said plurality of protrusions of said first tensioning member is greater than a height of said plurality of protrusions of said second tensioning member and said third tensioning member.

11. A method for manufacturing a tensioning member for an inflatable product, the method comprising: providing a sheet; and cutting the sheet to form at least two tensioning members; wherein each tensioning member of the at least two tensioning members comprises a base and a plurality of protrusions; wherein the base and the plurality of protrusions are formed from a single sheet of material; and wherein each protrusion of the plurality of protrusions extends from the base in a same direction and are spaced apart from one another.

12. The method according to claim 11, wherein said cutting comprises die-cutting, blanking, or thermal cutting the sheet to form the at least two tensioning members.

13. The method according to claim 11, further including providing a connector, wherein the connector is coupled to each protrusion of the plurality of protrusions.

14. The method according to claim 11, further including joining the at least two tensioning members.

15. The method according to claim 14, wherein said joining comprises coupling an end of each protrusion of one of the at least two tensioning members to an end of each protrusion of the other tensioning member of the at least two tensioning members.

16. The method according to claim 11, wherein the at least two tensioning members include a plurality of three tensioning members, and the method further includes joining the plurality of three tensioning members.

17. The method according to claim 16, wherein joining comprises coupling an end of each protrusion of each tensioning member of the plurality of three tensioning members to one another.

18. A method for manufacturing an inflatable product, wherein the inflatable product has a first wall, a second wall, and a sidewall, the method comprising: providing a sheet; cutting the sheet to form at least two tensioning members; wherein each tensioning member of the at least two tensioning members comprises a base and a plurality of protrusions; wherein the base and the plurality of protrusions are formed from a single sheet of material; wherein each protrusion of the plurality of protrusions extends from the base in a same direction and are spaced apart from one another; and joining the at least two tensioning members to the inflatable product.

19. The method according to claim 18, wherein joining comprises coupling the base of each tensioning member of the at least two tensioning members to the first wall and coupling each protrusion of the plurality of protrusions of each tensioning member of the at least two tensioning members to the second wall.

20. The method according to claim 18 further including providing a connector; wherein said joining comprises coupling the base of each tensioning member of the at least two tensioning members to the first wall and coupling each protrusion of the plurality of protrusions of each tensioning member of the at least two tensioning members to the second wall using the connector.

21. The method according to claim 18 further including joining the at least two tensioning members by coupling an end of each protrusion of one of the at least two tensioning members to an end of each protrusion of the other tensioning member of the at least two tensioning members; wherein said joining the at least two tensioning members to the inflatable product comprises coupling the base of one tensioning member of the at least two tensioning members to the first wall and coupling the base of the other tensioning member of the at least two tensioning members to the second wall.

22. The method according to claim 18, wherein the at least two tensioning members includes a plurality of three tensioning members, and the method further includes: joining the plurality of three tensioning members by coupling an end of each protrusion of each tensioning member of the plurality of three tensioning members to one another; wherein said joining the at least two tensioning members to the inflatable product comprises coupling the base of the first tensioning member to the first wall, coupling the base of the second tensioning member to the second wall, and coupling the base of the third tensioning member to the second wall.
